(19) United States
(12) Patent Application Publication
(10) Pub. No.: US 2016/0095009 A1
(43) Pub. Date: Mar. 31, 2016

(54) OCCUPANCY NOTIFICATIONS FOR UNLICENSED FREQUENCY BANDS

(71) Applicant: Alcatel-Lucent USA Inc., Murray Hill, NJ (US)

(72) Inventors: Jonathan Ling, North Brunswick, NJ (US); Mohammad R. Khawer, Lake Hopatcong, NJ (US); Teck H. Hu, Melbourne, FL (US)

(73) Assignee: Alcatel-Lucent USA Inc., Murray Hill, NJ (US)

(21) Appl. No.: 14/496,440

(22) Filed: Sep. 25, 2014

(51) Int. Cl. H04W 24/10; H04W 16/14

(52) U.S. Cl. CPC H04W 24/10; H04W 16/14

(57) ABSTRACT

A node identifies at least one first channel of an unlicensed frequency band that is occupied by a first node that operates according to a first radio access technology (RAT). The node transmits a signal on a second channel of the unlicensed frequency band. The signal is formed according to a second RAT used for transmission on the second channel and the signal includes information identifying the at least one second channel of the unlicensed frequency band.

### BACKGROUND

1. Field of the Disclosure

The present disclosure relates generally to wireless communication and, more particularly, to wireless communication in unlicensed frequency bands.

2. Description of the Related Art

Unlicensed frequency bands are portions of the radiofrequency spectrum that do not require a license for use and may therefore be used by any device to transmit or receive radiofrequency signals. For example, the Unlicensed National Information Infrastructure (UNII) is formed of portions of the radio spectrum that include frequency bands in the range of 5.15 gigahertz (GHz) to 5.825 GHz. For another example, the industrial, scientific, and medical (ISM) radio bands are portions of the radio spectrum that are reserved internationally for unlicensed communication. The ISM radio bands include bands with a center frequency of 2.4 GHz and a bandwidth of 100 megahertz (MHz), a center frequency of 5.8 GHz and a bandwidth of 150 MHz, and a center frequency of 24.125 GHz and a bandwidth of 250 MHz, among other frequency bands. Unlicensed frequency bands can be contrasted to licensed frequency bands that are licensed to a particular service provider and can only be used for wireless communication that is authorized by the service provider.

Wireless communication devices that transmit or receive signals in licensed or unlicensed frequency bands are typically referred to as nodes, which may include Wi-Fi access points that operate according to 802.11 standards defined by the Institute of Electrical and Electronics Engineers (IEEE) for the unlicensed spectrum or base stations that operate in the licensed spectrum according to standards such as Long Term Evolution (LTE) standards defined by the Third Generation Partnership Project (3GPP). Base stations that operate according to LTE may also implement supplementary downlink (SDL) channels in the unlicensed spectrum to provide additional bandwidth for downlink communications to user equipment that are also communicating with the base station using channels in a licensed frequency band.

The channels of the unlicensed frequency band used by Wi-Fi access points are divided into primary channels and secondary channels. The secondary channels may be bound to the primary channel to create a larger bandwidth channel. For example, Wi-Fi access points that operate according to the 802.11n standards in the 5 GHz band may define a 40 MHz channel that includes a 20 MHz primary channel that is bound to an adjacent 20 MHz secondary channel that is either one channel number before or after the primary channel number. Wi-Fi access points that operate according to the 802.11 ac standards may define larger channel bandwidths such as an 80 MHz channel that includes a 20 MHz primary channel that is bound to three 20 MHz secondary channels or a 160 megahertz channel that includes a 20 MHz primary channel that is bound to seven 20 MHz secondary channels.

Wi-Fi access points transmit beacon signals to notify other Wi-Fi access points that they are transmitting signals in one or more channels. For example, a Wi-Fi access point may transmit a beacon signal on its primary channel that conveys information identifying the access point, the primary channel, and, in some instances, the secondary channel. Other Wi-Fi access points may use the information in the beacon signal, as well as the frequency of the channel used to convey the beacon signal and the received signal strength of the beacon signal, to select primary or secondary channels for downlink transmissions. For example, other nodes may select primary or secondary channels that are different than the primary or secondary channels indicated in the beacon signal. For another example, the other nodes may decide to share the primary or secondary channels indicated in the beacon signal. Wi-Fi access points may also use the information identifying the primary channels in its channel selection algorithm. For example, if the Wi-Fi access point determines that too many other Wi-Fi access points are already using a channel as their primary channels, the Wi-Fi access point may choose some other channel.

Wi-Fi access points detect nodes that operate according to other radio access technologies (RATs) using indirect measurements. For example, a Wi-Fi access point that is transmitting on a first channel may measure the received signal strength on a second channel to determine whether the second channel is occupied by other nodes such as an LTE base station that is transmitting in the unlicensed frequency band. The occupancy measurement may be able to detect a noise rise in the second channel caused by downlink transmissions on the second channel by the LTE base station, but the Wi-Fi access point may not be able to distinguish this noise rise from other sources of noise. Moreover, the Wi-Fi access point must interrupt downlink transmissions to other nodes on the first channel to perform the occupancy measurements on the second channel, thereby reducing the available bandwidth for downlink transmissions.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method is provided for transmitting occupancy notifications for channels in an unlicensed frequency band. The method includes identifying at least one first channel of an unlicensed frequency band that is occupied by a first node that operates according to a first radio access technology (RAT). The method also includes transmitting a signal on a second channel of the unlicensed frequency band. The signal is formed according to a second RAT used for transmission on the second channel and the signal includes information identifying the one or more first channels of the unlicensed frequency band.

In some embodiments, a method is provided for transmitting occupancy information. The method includes providing, from a first node that operates according to a first radio access technology (RAT) to a second node that operates according to a second RAT, information identifying one or more first channels of an unlicensed frequency band that is occupied by the first node. The second node transmits a signal formed according to a second RAT that includes the information identifying the one or more first channels.

In some embodiments, a method is provided for receiving occupancy information. The method includes receiving, at a first node that operates according to a first radio access technology (RAT), a signal on a first channel of an unlicensed frequency band comprising information identifying one or more second channels of the unlicensed frequency band that are occupied by a second node that operates according to a second RAT. The method also includes performing channel selection in the unlicensed frequency band at the first node based on the information identifying the one or more second channels.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of an example of a wireless communication system according to some embodiments.

FIG. 2 is a diagram showing a first set of allocations of time intervals in a gating cycle for downlink transmissions by a base station on two channels of an unlicensed frequency band according to some embodiments.

FIG. 3 is a diagram showing a second set of allocations of time intervals in a gating cycle for downlink transmissions by a base station on two channels of an unlicensed frequency band according to some embodiments.

FIG. 4 is an illustration of an example of a beacon signal according to some embodiments.

FIG. 5 is an illustration of another example of a beacon signal according to some embodiments.

FIG. 6 is an illustration of an example of a format for one or more fields of a beacon signal according to some embodiments.

FIG. 7 is a flow diagram of a method for generating and transmitting occupancy information according to some embodiments.

FIG. 8 is a flow diagram of a method for performing channel selection based on occupancy information according to some embodiments.

FIG. 9 is a diagram of another example of a wireless communication system according to some embodiments.

FIG. 10 is a flow diagram of a method for relaying channel occupancy information according to some embodiments.

### DETAILED DESCRIPTION

Downlink transmissions in an unlicensed frequency band by a first node that operates according to a first radio access technology (RAT) and one or more second nodes that operate according to a second RAT may be coordinated by transmitting a signal that is formed according to the second RAT and indicates one or more channels of the unlicensed frequency band that are occupied by the first node. For example, a Wi-Fi beacon signal may be broadcast to notify neighboring Wi-Fi access points that an LTE base station is occupying the one or more channels. The beacon signal may be broadcast by a node that operates according to the second RAT and has a trusted relationship with the first node. The node may therefore receive information from the first node indicating the one or more channels that are occupied by the first node and broadcast the beacon signal on behalf of the first node. The beacon signal may also be relayed by user equipment that are connected to the first node. For example, the user equipment may connect to the first node and store information identifying the one or more channels of the unlicensed frequency band that are occupied by the first node. The user equipment may subsequently receive a request signal from one of the second nodes that requests measurement information from the user equipment, e.g., measurement requests conveyed according to the IEEE 802.11k protocol.

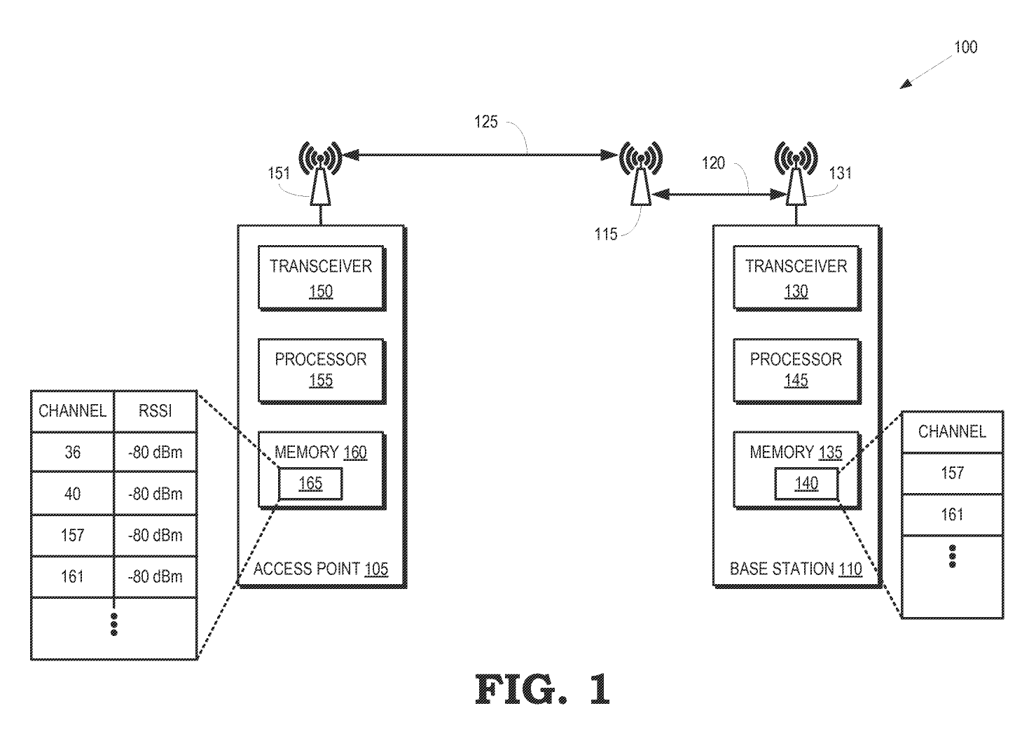

FIG. 1 is a diagram of an example of a wireless communication system 100 according to some embodiments. The wireless communication system 100 includes a plurality of nodes 105, 110, 115 that operate according to different RATs. In the illustrated embodiment, the node 105 is an access point (and hence also referred to herein as “access point 105”) that operates according to a first RAT such as the Wi-Fi standards defined by one or more IEEE 802.11 standards and the node 110 is a base station (and hence also referred to herein as “base station 110”) that operates according to a second (different) RAT such as the LTE standards defined by the 3GPP. The node 115 may also be an access point 115 that operates according to the first RAT.

The access point 105 may transmit or receive signals or messages over an air interface in an unlicensed frequency band. For example, the access point 105 may transmit or receive messages using the Unlicensed National Information Infrastructure (UNII), which is formed of portions of the radio spectrum that include frequency bands in the range of 5.15 GHz to 5.825 GHz. The access point 105 may transmit signals or messages to user equipment (not shown in FIG. 1) or receive messages from the user equipment on one or more channels of the unlicensed frequency band that may include a primary channel and one or more secondary channels. The access point 105 may also transmit or receive signals or messages over an air interface 125 between the access point 105 and the access point 115. Some embodiments of the access point 115 may transmit a beacon signal over the air interface 125 and the access point 105 may use information conveyed in the beacon signal to select primary or secondary channels for transmission, as discussed herein.

The base station 110 may support wireless connectivity to other nodes such as user equipment (not shown in FIG. 1). For example, the base station 110 may communicate with other nodes over one or more uplink channels and one or more downlink channels in a licensed frequency band. The base station 110 may also communicate with other nodes over a supplementary downlink channel in an unlicensed frequency band. However, since the base station 110 operates according to a different RAT than the access point 105, the base station 110 is not able to directly signal information indicating its occupancy of channels in the unlicensed frequency band to the access point 105. Some embodiments of the base station 110 may therefore rely on the access point 115 to provide this information, e.g., by broadcasting a beacon signal that includes information identifying the channels that are occupied by the base station 110. A single message may be transmitted to collectively identify a plurality of occupied channels or separate messages may be transmitted to individually identify each occupied channel. Some embodiments of the base station 110 may also rely on the access point 115 to provide other information such as information indicating a percentage of time that the base station 110 occupies one or more of the channels of the unlicensed frequency band, as discussed herein.

The base station 110 and the access point 115 may have a trusted relationship that allows the base station 110 and the access point 115 to exchange information securely. For example, the access point 115 may be built into the same physical device or structure as the base station 110 so that the access point 115 and the base station 110 can exchange information securely over a wired connection within the physical device or structure. Alternatively, the base station 110 and the access point 115 may be implemented in separate physical devices or structures and may establish a trusted relationship over a wired or wireless communication link 120. The trusted relationship in this scenario may be established using a handshaking protocol or an authentication protocol such as a challenge/response protocol based on a shared secret key that is known to the base station 110 and the access point 115.

The base station 110 includes a transceiver 130 that is coupled to an antenna 131. The transceiver 130 may transmit messages or signals over downlink channels in the licensed frequency band or the supplementary downlink channel in the unlicensed band. The transceiver 130 may also receive signals over the uplink channels. Some embodiments of the transceiver 130 may also transmit or receive information over the communication link 120 to the access point 115. The base station 110 includes memory 135 for storing information such as processor instructions, data for transmission, received data, and the like. In the illustrated embodiment, the memory 135 includes a table 140 (or other data structure) that is used to store information identifying the channels of the unlicensed frequency band that are occupied by the base station 110. For example, the table 140 indicates that channels 157 and 161 are currently occupied by the base station 110 for downlink transmissions in the unlicensed frequency band. A processor 145 may be used to process information for transmission, process received information, or perform other operations as discussed herein, e.g., by executing instructions stored in the memory 135. For example, the processor 145 may generate messages including information identifying the occupied channels (as well as other occupancy information, as discussed herein) and instruct the transceiver 130 to provide the messages to the access point 115.

The access point 105 includes a transceiver 150 that is coupled to an antenna 151. The transceiver 150 may transmit signals or receive signals over one or more channels in the unlicensed frequency band. The access point 105 also includes a processor 155 and a memory 160. The processor 155 may be used to process information for transmission, process received information, or perform other operations as discussed herein, e.g., by executing instructions stored in the memory 160. Results of the operations may then be stored in the memory 160. For example, the transceiver 150 may receive messages including information identifying the channels occupied by the base station 110 (as well as other occupancy information, as discussed herein) that are broadcast over the air interface 125 by the access point 115. In some embodiments, the messages may be beacon signals that are broadcast by the access point 115.

The processor 155 may use information included in the messages to determine the channels used by the access point 115, a frequency of the channel used to transmit the message, the channels occupied by the base station 110, a received signal strength indicator (RSSI) for the message, or other measures of the channel quality such as a signal-to-noise ratio (SNR) or a signal-to-interference-plus-noise ratio (SINR). This information may then be stored in a table 165 (or other data structure) in the memory 160. In some embodiments, the measured properties of the received message may be used to estimate parameters of channels used by the access point 115 and the base station 110. For example, the processor 155 may estimate the RSSI for the primary channel 36 of the access point 115, the secondary channel 40 for the access point 115, the channel 157 for the base station 110, and the channel 161 for the base station 110 using the RSSI (−80 dBm) measured based on the received message. The processor 155 may use the stored information to perform channel selection for the access point 105.

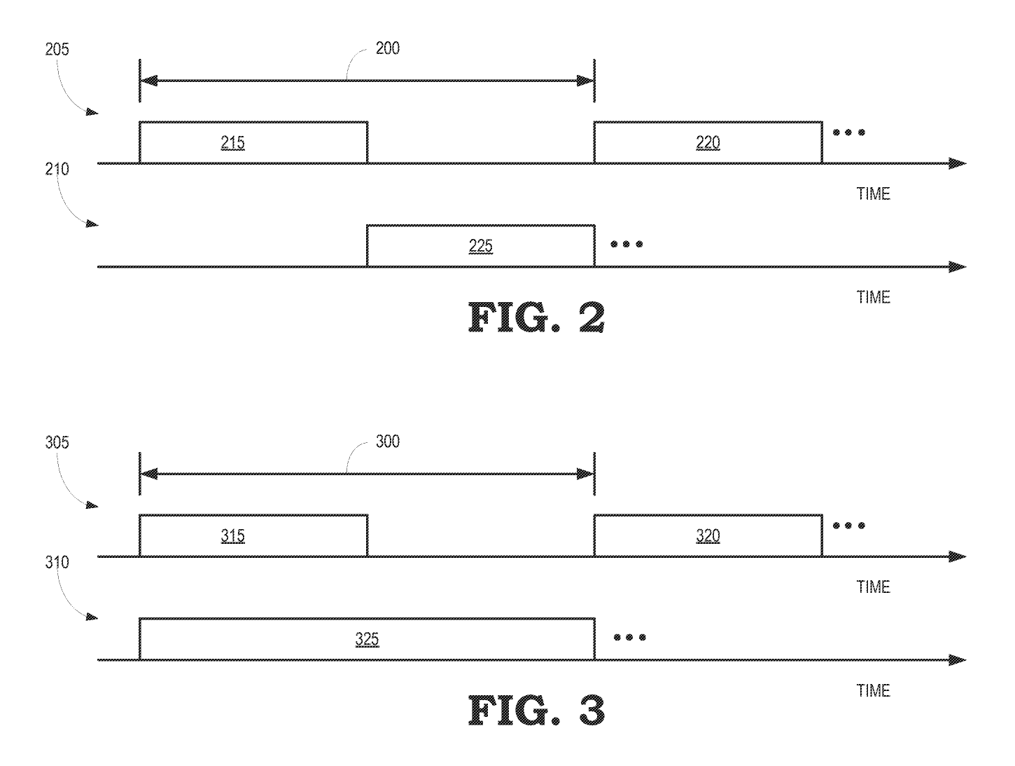

FIG. 2 is a diagram showing a first set of allocations of time intervals in a gating cycle 200 for downlink transmissions by a base station on two channels of an unlicensed frequency band according to some embodiments. The gating cycle 200 may repeat indefinitely or for a predetermined amount of time. A first allocation 205 indicates time intervals in the gating cycle 200 that are allocated to a first channel (such as the channel 157 occupied by the base station 110 shown in FIG. 1) and a second allocation 210 indicates time intervals in the gating cycle 200 that are allocated to a second channel (such as the channel 161 occupied by the base station 110 shown in FIG. 1). The horizontal axes indicate time increasing from left to right.

The time interval 215 in the gating cycle 200, as well as the time interval 220 in the subsequent gating cycle in a series of repeating gating cycles, may be allocated to the base station for downlink transmissions on the first channel of the unlicensed frequency band. Thus, the first channel is occupied approximately 50% of the time. The time interval 225 in the gating cycle 200 may be allocated to the base station for downlink transmissions on the second channel of the unlicensed frequency band. Thus, the second channel is occupied approximately 50% of the time. As discussed herein, the allocations 205, 210 may be used to determine the percentage of time that the first and second channels, respectively, are occupied by the base station. This information may be signaled to other devices (such as the access point 105 shown in FIG. 1) and used during channel selection by the other devices. For example, occupancy information indicating that the first and second channels are occupied approximately 50% of the time may be broadcast in a beacon signal or relayed to the other devices by another node such as user equipment, as discussed herein.

FIG. 3 is a diagram showing a second set of allocations of time intervals in a gating cycle 300 for downlink transmissions by a base station on two channels of an unlicensed frequency band according to some embodiments. The gating cycle 300 may repeat indefinitely or for a predetermined amount of time. A first allocation 305 indicates time intervals in the gating cycle 300 that are allocated to a first channel (such as the channel 157 occupied by the base station 110 shown in FIG. 1) and a second allocation 310 indicates time intervals in the gating cycle 300 that are allocated to a second channel (such as the channel 161 occupied by the base station 110 shown in FIG. 1). The horizontal axes indicate time increasing from left to right.

The time interval 315 in the gating cycle 300, as well as the time interval 320 in the subsequent gating cycle in a series of repeating gating cycles, may be allocated to the base station for downlink transmissions on the first channel of the unlicensed frequency band. Thus, the first channel is occupied approximately 50% of the time. The time interval 325 in the gating cycle 200 may be allocated to the base station for downlink transmissions on the second channel of the unlicensed frequency band. Thus, the second channel is occupied approximately 100% of the time. As discussed herein, the allocations 305, 310 may be used to determine the percentage of time that the first and second channels, respectively, are occupied by the base station. This information may be signaled to other devices (such as the access point 105 shown in FIG. 1) and used during channel selection by the other devices. For example, occupancy information indicating that the first and second channels are occupied approximately 75% of the time may be broadcast in a beacon signal or relayed to the other devices by another node such as user equipment, as discussed herein.

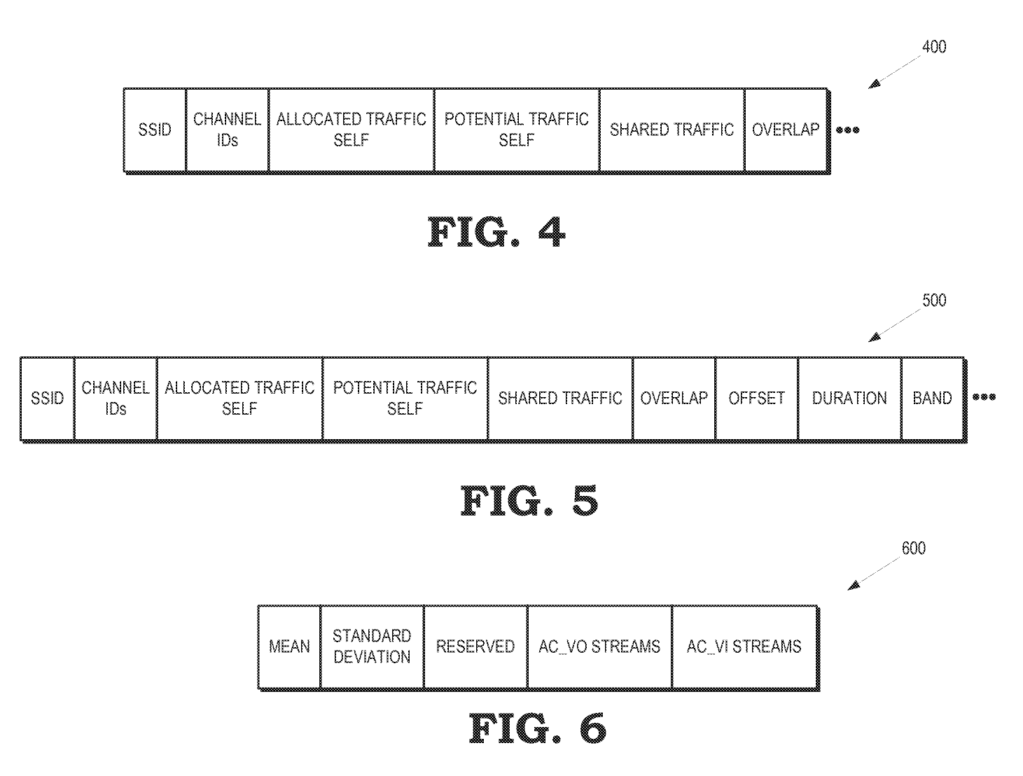

FIG. 4 is an illustration of an example of a beacon signal 400 according to some embodiments. The beacon signal 400 may be generated and transmitted by embodiments of the access point 115 shown in FIG. 1. Although the beacon signal 400 is generated according to a first RAT (such as Wi-Fi), the beacon signal may be used to signal channel occupancy information for devices that operate according to a different RAT (such as LTE). The beacon signal 400 includes an identifier field (SSID) that identifies the entity associated with the beacon signal 400. For example, if an access point is broadcasting the beacon signal 400 to notify other access points that it is transmitting on a primary channel and one or more secondary channels, the SSID identifies the access point. For another example, if the access point is broadcasting the beacon signal 400 on behalf of another device (such as the base station 110 shown in FIG. 1), the SSID identifies the other device. The beacon signal 400 also includes a channel identifier field (CHANNEL IDs) that includes information identifying the one or more channels that are occupied by the device identified in the SSID field. In some embodiments, the channel identifier field may also include information indicating whether the channels are primary channels or secondary channels.

Some embodiments of the beacon signal 400 may include additional occupancy information. For example, the beacon signal 400 may include additional fields to characterize traffic on the channels of the unlicensed frequency band. A first field (Allocated Traffic Self) may include information indicating the total quality of service (QoS) traffic and numbers of different types of active streams such as audio (AC_V0) and video (AC_V1) streams. A second field (Potential Traffic Self) may include information indicating the potential QoS traffic load expected by the device. A third field (Shared Traffic) may include information indicating a sum of the values in the first field. A fourth field (Overlap) includes information indicating the number of other access points (or other devices) that are sharing the same channel and whose beacons have been detected or obtained within a predetermined number of previous beacon periods or gating cycles. Some embodiments of the beacon signal 300 may include more or fewer fields for conveying other occupancy information for channels of the unlicensed frequency band.

FIG. 5 is an illustration of another example of a beacon signal 500 according to some embodiments. The beacon signal 500 may be generated and transmitted by embodiments of the access point 115 shown in FIG. 1. As discussed herein, the beacon signal 500 may be used to signal channel occupancy for devices that operate according to different RATs (such as Wi-Fi and LTE). The beacon signal 500 differs from the beacon signal 400 shown in FIG. 4 because the beacon signal 500 includes additional fields that are used to indicate a fraction of time that the channels identified in the CHANNEL ID field are occupied. Some embodiments of the beacon signal 500 include a fifth field (Offset) that indicates the beginning of the next allocated time interval such as the time intervals 215, 220, 225 shown in FIG. 2 or the intervals 315, 320, 325 shown in FIG. 3. For example, the values of the fifth field in the beacon signal 500 may indicate the beginning of the next allocated time interval for the channels (in microseconds) relative to a reference time such as the time at which the beacon signal 500 is transmitted. A sixth field (Duration) may indicate a duration of the next allocated time interval (in microseconds) and a duration of the next subsequent off period for the channels. A seventh field (Band) may indicate whether the channels include a primary channel, a secondary channel, or both.

FIG. 6 is an illustration of an example of a format 600 for one or more fields of a beacon signal according to some embodiments. The format 600 may be used for fields such as the Allocated Traffic Self field or the Potential Traffic Self field in the beacon signals 400, 500 shown in FIG. 4 and FIG. 5, respectively. The first field (Mean) of the format 600 indicates a mean level of occupancy in terms of airtime and the second field (Standard Deviation) of the format 600 indicates the standard deviation of occupancies relative to the mean over several time intervals such as the gating cycles 200, 300 shown in FIG. 2 and FIG. 3, respectively. A third field (Reserved) may be reserved for other uses. A fourth field (AC_VO Streams) indicates a number of audio streams and a fifth field (AC_VI Streams) indicates a number of video streams.

The fields of the beacon signals 400, 500 shown in FIG. 4 and FIG. 5, respectively, may be used to indicate a percentage of time that one or more channels of the unlicensed frequency bands are occupied by a device such as a base station that operates according to LTE. For example, the Mean field in the Allocated Traffic Self field or the Potential Traffic Self field may be determined based upon the percentage of a gating cycle (such as the gating cycles 200, 300 shown in FIG. 2 and FIG. 3) that is allocated to a base station for transmission over one or more channels of the unlicensed frequency band. For example, if a base station occupies two channels (which may be referred to as a primary channel and a secondary channel), the value of the Mean fields in the Allocated Traffic Self field or the Potential Traffic Self field may be set to one second per second (1 s/s) if both the primary channel and the secondary channel are occupied for the entire duration of the gating cycle. The value of the Mean field may be set to 0.75 s/s if the primary channel is occupied for the entire duration of the gating cycle and the secondary channel is occupied for 50% of the gating cycle. The value of the Mean field may be set to 0.5 s/s if the primary channel is occupied for 50% of the gating cycle and the secondary channel is occupied for 50% of the gating cycle. Values of the other fields in the format (e.g., Standard Deviation, AC_VO Streams, or AC_VO Streams) may be set to arbitrary values.

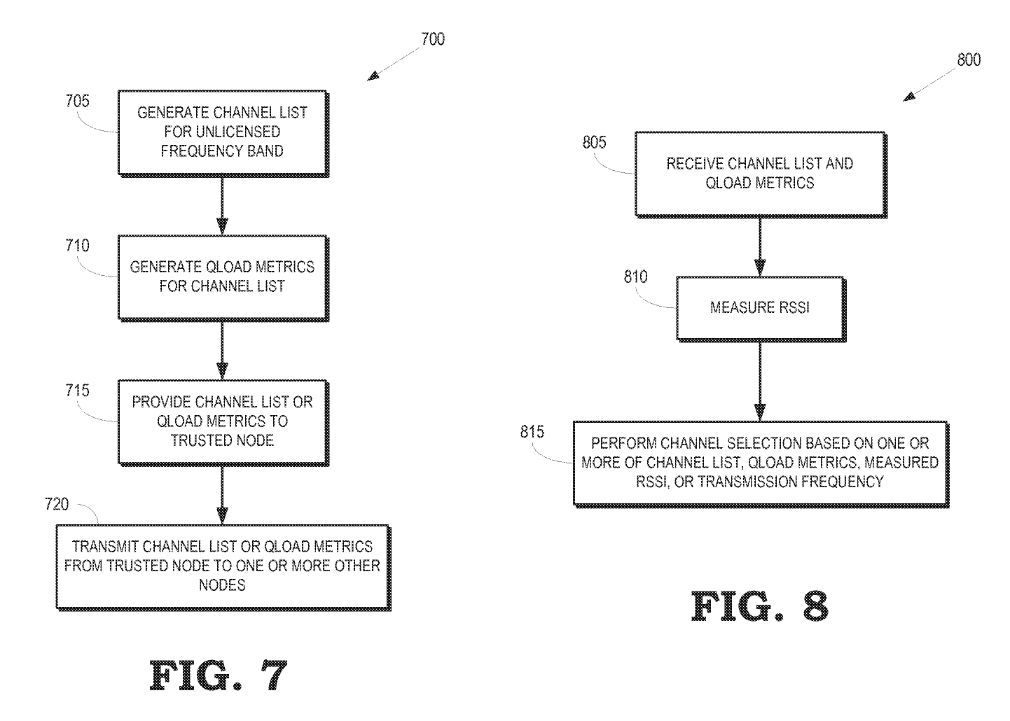

FIG. 7 is a flow diagram of a method 700 for generating and transmitting occupancy information according to some embodiments. The method 700 may be implemented in embodiments of nodes such as the base station 110 and the access point 115 shown in FIG. 1. At block 705, a first node that operates according to a first RAT generates a channel list that identifies channels of an unlicensed frequency band that are occupied by the first node. At block 710, some embodiments of the first node may generate additional occupancy information (which may be referred to as QLoad metrics) that indicates a percentage of the time that channels in the channel list are occupied by the first node. At block 715, the first node provides the channel list and, in some cases, the QLoad metrics to a second node that operates according to a second RAT. In some embodiments, the first node and the second node may have a trusted relationship that allows secure communication between the first and second nodes. The second node may therefore be referred to as a trusted node.

At block 720, the trusted node transmits information indicating the channel list and, in some cases, the QLoad metrics associated with the channels indicated in the channel list. Some embodiments of the trusted node broadcast the channel list and, in some cases, the QLoad metrics at predetermined time intervals. In addition to or instead of broadcasting the information at predetermined time intervals, some embodiments of the trusted node may transmit the channel list and, in some cases, the QLoad metrics to one or more other nodes that operate according to the second RAT in response to receiving a request signal from the one or more other nodes. Transmitting the information may include transmitting one or more messages including the information indicating the channel list and, in some cases, the QLoad metrics associated with the channels indicated in the channel list. The signals or messages may be formed according to the second RAT.

FIG. 8 is a flow diagram of a method 800 for performing channel selection based on occupancy information according to some embodiments. The method 800 may be implemented in embodiments of a first node that operates according to a first RAT such as the access point 105 shown in FIG. 1. At block 805, the first node receives a signal including information indicating a channel list of one or more channels that are occupied by a second node that operates according to a second RAT. The information may be received in a beacon signal broadcast by a third node that operates according to the first RAT or in a probe response that is transmitted by the third node in response to a request signal transmitted by the first node. The first node may also receive one or more QLoad metrics associated with the channels indicated in the channel list. At block 810, the first node measures a received signal strength indicator (RSSI) for the received signal and determines a transmission frequency used to transmit the received signal. At block 815, the first node performs channel selection based on the channel list, (in some cases) the received QLoad metrics, the measured RSSI, or the transmission frequency. For example, the first node may select one or more channels for transmission by selecting a free channel that is not occupied by any other nodes or, if no free channels are available, selecting channels with the lowest interference.

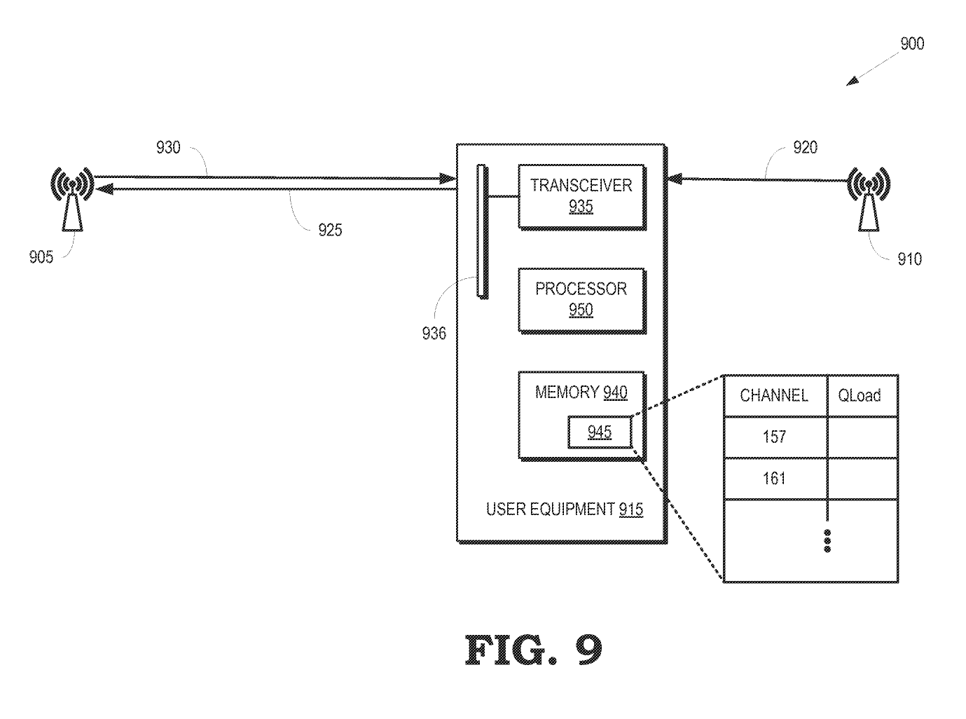

FIG. 9 is a diagram of another example of a wireless communication system 900 according to some embodiments. The wireless communication system 900 includes a plurality of nodes 905, 910, 915 that operate according to different RATs. In the illustrated embodiment, the node 905 is an access point 905 that operates according to a first RAT such as the Wi-Fi standards defined by one or more IEEE 802.11 standards and the node 910 is a base station 910 that operates according to a second (different) RAT such as the LTE standards defined by the 3GPP. Some embodiments of the access point 905 may be implemented in the same manner as the access point 105 shown in FIG. 1. Some embodiments of the base station 910 may be implemented in the same manner as the base station 110 shown in FIG. 1. The node 915 is a user equipment 915 that operates according to the first RAT and the second RAT.

The access point 905 may transmit or receive signals or messages over an air interface in an unlicensed frequency band. The base station 910 may communicate with other nodes (such as the user equipment 915) over one or more uplink channels and one or more downlink channels in a licensed frequency band. The base station 910 may also communicate with other nodes over a supplementary downlink channel in an unlicensed frequency band. However, the base station 910 is not able to directly signal information indicating its occupancy of channels in the unlicensed frequency band to the access point 905 since the base station 910 operates according to a different RAT than the access point 905. The user equipment 915 may therefore relay occupancy information from the base station 910 to the access point 905. For example, the user equipment 915 may acquire the occupancy information using a wireless communication link 920 established with the base station 910. The occupancy information may be stored and subsequently provided to the access point 905 over a channel 925 of the unlicensed frequency band in response to a request signal 930 received from the access point 905.

The user equipment 915 includes a transceiver 935 that is coupled to an antenna 936. The transceiver 935 may operate according to the first RAT or the second RAT and therefore the transceiver 935 may transmit or receive messages or signals over channels in the licensed frequency band or the unlicensed band. For example, the transceiver 935 may be used to exchange messages or signals with the access point 905 according to the first RAT or the base station 910 according to the second RAT. The user equipment 915 includes memory 940 for storing information such as processor instructions, data for transmission, received data, and the like. In the illustrated embodiment, the memory 940 includes a table 945 (or other data structure) that is used to store information identifying the channels of the unlicensed frequency band that are occupied by the base station 910. For example, the table 945 indicates that channels 157 and 161 are currently occupied by the base station 910 for downlink transmissions in the unlicensed frequency band. The table 945 may also be used to store, in some cases, occupancy information such as QLoad metrics and other occupancy information described herein. A processor 950 may be used to process information for transmission, process received information, or perform other operations as discussed herein, e.g., by executing instructions stored in the memory 940. For example, the processor 950 may acquire the channel information and, in some cases, other occupancy information in response to the user equipment 915 establishing a wireless communication link 920 with the base station 910. This information may then be stored in the table 945. The processor 950 may subsequently generate messages (such as a radio measurement report) including information identifying the occupied channels (as well as other occupancy information, as discussed herein) and instruct the transceiver 935 to provide the messages to the access point 905.

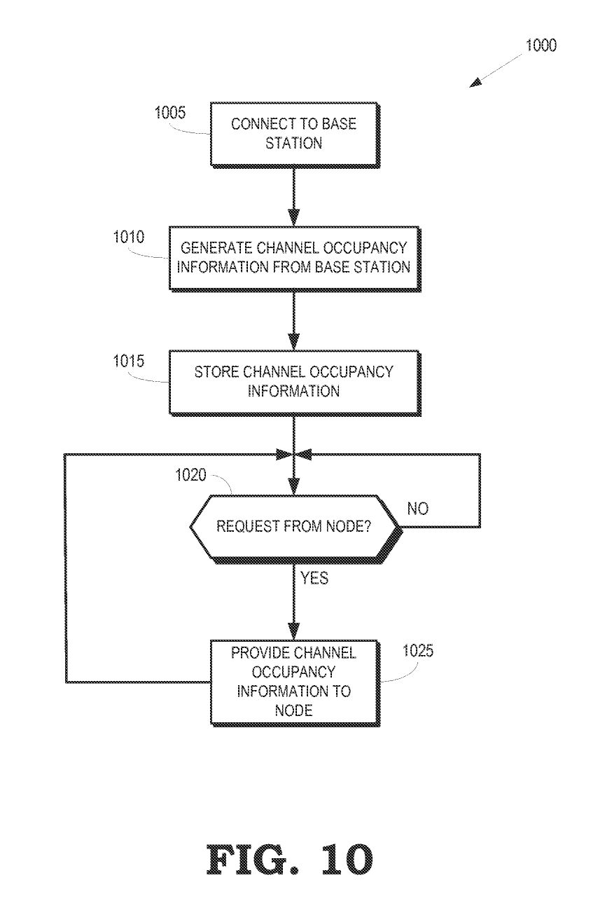

FIG. 10 is a flow diagram of a method 1000 for relaying channel occupancy information according to some embodiments. The method 1000 may be implemented in some embodiments of the user equipment 915 shown in FIG. 9. At block 1005, the user equipment connects to a base station that operates according to a first RAT, e.g., by establishing a wireless communication link over an air interface to the base station. At block 1010, the user equipment generates channel occupancy information for the base station. For example, the user equipment may request the channel occupancy information from the base station or the base station may autonomously transmit the channel occupancy information to the user equipment (e.g., at predetermined time intervals). The user equipment may then use the explicitly signaled channel occupancy information to generate information used to identify channel occupancy of the base station to other nodes using signaling formed according to the second RAT. For another example, the user equipment may generate the channel occupancy information using signals that implicitly indicate the channel occupancy of the base station. The implicit indications may include physical layer (PHY) signaling, medium access control (MAC) layer signaling, received power, transmission activity, and the like. At block 1015, the user equipment stores the channel occupancy information, e.g., in a memory such as the memory 940 shown in FIG. 9. The user equipment may then wait for a request signal from another node that operates according to a second RAT, such as the access point 905 shown in FIG. 9.

At decision block 1020, the user equipment determines whether it has received a request signal from a node. If not, the user equipment continues to wait for request signal. If the user equipment receives a request signal from the node, the user equipment provides the storage channel occupancy information to the requesting node. For example, the user equipment may transmit a radio measurement report including information indicating the occupancy information at block 1025. The radio measurement report may be formed according to the second RAT. The stored occupancy information may become stale over time and so some embodiments of the user equipment may periodically repeat some or all of the method 1002 refresh the stored occupancy information. For example, the user equipment may periodically transmit requests for occupancy information to the base station at a predetermined time interval and store the newly acquired channel occupancy information. In some embodiments, the radio measurement report may be transmitted autonomously by the user equipment (e.g., as a beacon signal that is broadcast at predetermined time intervals) in addition to or instead of being transmitted in response to a request signal received from another node.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
identifying at least one first channel of an unlicensed frequency band that is occupied by a first node that operates according to a first radio access technology (RAT); and
transmitting a signal on a second channel of the unlicensed frequency band, wherein the signal is formed according to a second RAT used for transmission on the second channel, and wherein the signal comprises information identifying the at least one first channel of the unlicensed frequency band.

2. The method of claim 1, wherein the first RAT is defined by Long Term Evolution (LTE) standards, and wherein the second RAT is defined by Wi-Fi standards.

3. The method of claim 1, wherein transmitting the signal comprises transmitting a beacon signal from a second node that operates according to the second RAT in response to the second node receiving the information identifying the at least one first channel from the first node.

4. The method of claim 1, wherein transmitting the signal comprises autonomously broadcasting a beacon signal from user equipment having a wireless communication link to the first node or transmitting a radio measurement report from the user equipment in response to a request signal received from a third node that operates according to the second RAT.

5. The method of claim 4, further comprising:
establishing the wireless communication link between the user equipment and the first node;
generating the information identifying the at least one second channel from the first node in response to establishing the wireless communication link; and
storing the information identifying the at least one second channel at the user equipment prior to receiving the request signal from the third node.

6. The method of claim 1, wherein the signal further comprises information indicating a fraction of time that the first node occupies the at least one second channel.

7. A method comprising:
providing, from a first node that operates according to a first radio access technology (RAT) to a second node that operates according to a second RAT, information identifying at least one first channel of an unlicensed frequency band that is occupied by the first node, wherein the second node transmits a signal formed according to a second RAT that includes the information identifying the at least one first channel.

8. The method of claim 7, wherein the first RAT is defined by Long Term Evolution (LTE) standards, and wherein the second RAT is defined by Wi-Fi standards.

9. The method of claim 7, further comprising:
forming a trusted relationship between the first node and the second node prior to providing the information identifying the at least one first channel to the second node.

10. The method of claim 9, wherein providing the information identifying the at least one first channel comprises providing the information identifying the at least one first channel over a wired connection between the first node and the second node.

11. The method of claim 7, wherein providing the information to the second node comprises providing the information to user equipment having a wireless communication link to the first node for configuring the user equipment to generate a radio measurement report in response to a request signal received from a third node that operates according to the second RAT.

12. The method of claim 11, further comprising:
establishing the wireless communication link between the user equipment and the first node; and
providing the information identifying the at least one second channel from the first node in response to establishing the wireless communication link and prior to the user equipment receiving the request signal from the third node.

13. The method of claim 7, wherein providing the information further comprises providing information indicating a fraction of time that the first node occupies the at least one first channel.

14. A method comprising:
receiving, at a first node that operates according to a first radio access technology (RAT), a signal on a first channel of an unlicensed frequency band comprising information identifying at least one second channel of the unlicensed frequency band that is occupied by a second node that operates according to a second RAT; and
performing channel selection in the unlicensed frequency band at the first node based on the information identifying the at least one second channel.

15. The method of claim 14, wherein the first RAT is defined by Wi-Fi standards, and wherein the second RAT is defined by Long Term Evolution (LTE) standards.

16. The method of claim 14, wherein the signal further comprises information indicating a fraction of time that the first node occupies the at least one second channel.

17. The method of claim 14, wherein receiving the signal comprises receiving a beacon signal from a third node that operates according to the second RAT in response to the third node receiving the information identifying the at least one second channel from the second node.

18. The method of claim 14, wherein receiving the signal comprises receiving a radio measurement report from user equipment having a wireless communication link to the second node.

19. The method of claim 18, further comprising:
transmitting a request signal to request the radio measurement report from the user equipment; and
receiving the measurement report in response to transmitting the request signal.

20. The method of claim 14, wherein performing the channel selection comprises selecting at least one third channel that is different than the at least one second channel.
